(19) United States
(12) Patent Application Publication
(10) Pub. No.: US 2026/0048384 A1
(43) Pub. Date: Feb. 19, 2026

(54) CATALYTICALLY ACTIVE COMPOSITION CONTAINING RUTHENIUM FOR CATALYSTS FOR THE EXHAUST-GAS AFTERTREATMENT

(71) Applicant: HERAEUS PRECIOUS METALS GMBH & CO. KG, Hanau (DE)

(72) Inventors: Marcus BONIFER, Hanau (DE); Pragati JOSHI, Hanau (DE)

(21) Appl. No.: 19/102,987

(22) PCT Filed: Jun. 16, 2023
(86) PCT No.: PCT/EP2023/066206

§ 371 Date: Feb. 11, 2025

(30) Foreign Application Priority Data
Aug. 17, 2022 (EP) 22190680.3

(51) Int. Cl. B01J 23/63; B01D 53/94; B01J 21/04; B01J 35/00; B01J 37/04

(52) U.S. Cl. CPC B01J 23/63; B01D 53/94; B01J 21/04; B01J 35/19; B01J 37/04; B01D 2255/1026; B01D 2255/2092; B01D 2255/407

(57) ABSTRACT

The present invention relates to a ruthenium-containing catalytically active composition for exhaust-gas aftertreatment catalysts, which composition contains a doped refractory oxide which is provided at least with ruthenium and is selected from the group consisting of aluminum oxide, magnesium oxide, silicon oxide, molybdenum oxide, tungsten oxide, titanium oxide, mixtures thereof, and composite oxides of two or more thereof and a cerium-zirconium oxide which comprises at least one element other than cerium from the group of rare earths. The invention also relates to a preparation containing the catalytically active composition, to methods for preparing same, to a catalyst having the catalytically active composition, and to a method in which the composition is used.

The present invention relates to a ruthenium-containing catalytically active composition for exhaust-gas aftertreatment catalysts, to a preparation containing the catalytically active composition, to methods for the preparation thereof, to a catalyst comprising the catalytically active composition, and to a method in which the composition is used.

A number of hazardous or environmentally harmful compounds are found in the exhaust emissions from chemical, industrial or fuel-consuming processes, for example from incinerators, gas turbines, industrial plants or internal combustion engines. For a long time now, the exhaust gas from internal combustion engines, particularly in motor vehicles, has been treated by means of a 3-way catalyst. The task of the catalyst is to convert the pollutants produced during combustion, in particular hydrocarbons (HC), carbon monoxide (CO) and nitrogen oxides (NOₓ) into the non-toxic substances carbon dioxide (CO₂), water (H₂O) and nitrogen (N₂). Other than the 3-way catalyst, oxidation catalysts and NOₓ storage catalysts are most commonly used.

Such catalysts typically contain at least one catalytically active noble metal component. The noble metals are applied to a carrier material and form the active centers on the surface of the catalyst. For example, catalysts used for oxidation reactions in exhaust-gas aftertreatment generally contain platinum, palladium, iridium and rhodium on a heat-resistant carrier, such as aluminum oxide, usually mixed with an oxygen storage material and applied to an inert substrate. The substrates are usually honeycomb bodies made of a ceramic material (e.g. cordierite) or a metal material (e.g. FeCrAl).

However, due to the high costs of large quantities of noble metals, efforts are being made to reduce the content of noble metals in catalysts and, in particular, to at least partially replace rhodium with alternatives. In addition, there is a desire for catalysts that cost less but are similarly capable of removing pollutants from exhaust gases from combustion reactions, for example from the emissions from chemical plants or motor vehicles. Ruthenium represents a more cost-effective alternative to rhodium as an active catalytic species.

The use of ruthenium-containing catalysts to reduce NOₓ and to oxidize CO and hydrocarbons is known in principle. One problem of using ruthenium is the tendency of the noble metal to form volatile and toxic oxides, which affects the durability of such systems. For example, US 2017107880 A1 discloses the use of a ruthenium-containing exhaust gas catalyst for reducing NOₓ. However, to achieve high activity and selectivity of the catalyst, regulation of the exhaust gas is necessary to ensure reducing conditions.

US 2006034740 A1 discloses the combination of ruthenium with another noble metal on an aluminum oxide carrier material for stabilization purposes. US 2003144143 A1 proposes using zirconium oxides and tin oxide to stabilize ruthenium-containing aluminum oxide-based catalysts.

US 2018229220 A1 discloses catalysts for the removal of volatile organic compounds (VOCs) from industrial exhaust gases, which contain tin oxide and silica and optionally other oxide stabilizers in addition to ruthenium and heat-resistant mixed oxides to stabilize the catalyst system. The catalysts are produced using washcoat processes in which the ruthenium is uniformly applied to all carrier materials as an active catalytic species.

The object of the present invention was to provide a ruthenium-containing catalytically active composition for exhaust-gas aftertreatment catalysts, which has favorable light-off behavior and increased stability. In particular, the object was to provide a catalytically active composition that enables the use of low-cost metal species in catalyst systems aimed at eliminating toxic emissions, such as carbon monoxide, hydrocarbons and other volatile organic compounds, and in particular nitrogen oxide species.

The “light-off temperature” indicates the temperature from which 50% of at least one of the compounds to be decomposed or a group of the compounds to be decomposed is converted. Below this minimum temperature, the catalytic effect is too low to ensure sufficient effectiveness of the catalytic oxidation reaction.

Furthermore, the object was to provide a method for preparing such a catalytically active composition, a preparation containing the catalytically active composition, and the preparation thereof, as well as a catalyst containing the catalytically active composition.

Surprisingly, it has been found that the object addressed by the present invention is achieved by a catalytically active composition which contains a doped refractory oxide which is provided at least with ruthenium and is selected from the group consisting of aluminum oxide, magnesium oxide, silicon oxide, molybdenum oxide, tungsten oxide, titanium oxide, mixtures thereof, and composite oxides of two or more thereof and a cerium-zirconium oxide which comprises at least one element other than cerium from the group of rare earths.

In particular, it has been found that the combination of a doped refractory oxide, on which at least ruthenium is carried as a catalytically active component, with a doped cerium-zirconium oxide results in the unexpected stabilization of the ruthenium in the catalytically active composition. In addition, the composition exhibits unexpectedly high catalytic activity, which enables particularly low loadings with the catalytically active species. The specific combination of the different components thus makes it possible to provide a comparatively inexpensive yet active and stable catalytically active composition.

The catalytically active composition according to the invention is suitable for use in exhaust-gas aftertreatment, in particular of oxygen-containing combustion exhaust gases. Examples of combustion exhaust gases include exhaust gases from mobile and stationary internal combustion engines, which, in addition to hydrocarbons and carbon monoxide, which are oxidized in the aftertreatment process, also contain nitrogen oxides, which are reduced from the exhaust gas. Other possible sources of treatable exhaust gases are combustion plants, gas turbines or industrial plants, such as refineries, chemical plants, sewage plants or waste incinerators. Said composition is particularly preferably used in the treatment of exhaust gases from internal combustion engines, in particular small engines, 2-stroke engines and engines that operate in the “rich” lambda range. Lambda (A) refers to the air-fuel ratio. This establishes a relationship between the air mass actually available for combustion and the minimum stoichiometric air mass required for complete combustion of the fuel. With regard to the stoichiometric fuel ratio, there is exactly the amount of air available to completely burn the fuel. This is indicated as λ=1. If more fuel is available, this is referred to as a rich mixture (λ<1), and if there is excess air, this is referred to as a lean mixture (λ>1).

The catalytically active composition comprises a doped refractory oxide. The term “refractory oxide” used here refers to a metal-containing oxide that is chemically and physically stable at high temperatures, particularly those associated with gasoline and diesel engine exhaust gases. Refractory oxides are often also referred to as heat-resistant oxides.

The refractory oxide is selected from the group consisting of aluminum oxide, magnesium oxide, silicon oxide, molybdenum oxide, tungsten oxide, titanium oxide, mixed oxides thereof and composite oxides of two or more thereof.

The term “mixed oxide” used here generally refers to a mixture of oxides in a single phase, as is commonly known in the relevant technical field. It is not used for physical mixtures of oxides, but refers to “solid solutions” with a uniform crystal lattice in which the individual metal oxides can no longer be distinguished. The term “composite oxide” used here refers to metal oxide agglomerates that do not have a uniform crystal lattice and in which phases of the individual metal oxides can be distinguished.

In preferred embodiments, the refractory oxide is aluminum oxide or a mixed oxide or composite oxide of aluminum oxide.

The refractory oxide is doped, in other words the refractory oxide comprises a dopant. Refractory oxides doped with a dopant are obtainable using methods known in the relevant technical field.

Suitable dopants can be selected from the group consisting of rare earth metals, transition metals, alkaline earth metals and mixtures thereof. In particular, the dopant may be at least one element selected from the group consisting of cerium (Ce), zirconium (Zr), titanium (Ti), silicon (Si), manganese (Mn), yttrium (Y), lanthanum (La), barium (Ba), praseodymium (Pr), gadolinium (Gd), samarium (Sm), and neodymium (Nd). Preferably, the dopant comprises La, Ba, Sr, Zr or Mn. The dopant is preferably in the form of an oxide.

Particularly preferably, the doped refractory oxide is a lanthanum oxide-doped aluminum oxide, a lanthanum oxide-doped mixed oxide of aluminum oxide, or a lanthanum oxide-doped composite oxide of aluminum oxide.

The total amount of dopant may be 0.2 to 6 wt. % (weight %), preferably 0.5 to 5 wt. % of the doped refractory oxide, particularly preferably 1 to 4 wt. %. The total amount of dopant used here refers to the weight of the doped refractory oxide.

It is preferable for the doped refractory oxide to have a large BET surface area, the BET surface area preferably being at least 30 m²/g, in particular at least 80 m²/g, particularly preferably at least 100 m²/g. Typically, the BET surface area of the doped refractory oxide is between 30 and 300 m²/g, preferably between 50 and 200 m²/g. The BET surface area is also called the specific surface area and can be determined according to ISO 9277:2010 using nitrogen as adsorbate.

The proportion of the doped refractory oxide in the catalytically active composition can be in the range of 10 to 95 wt. %, based on the total amount of the catalytically active composition, preferably in the range of 20 to 90 wt. %, in particular in the range of 30 to 85 wt. %.

The doped refractory oxide is preferably a porous material. The pore volume is typically in the range of 0.2 to 10.0 mL/g, in particular in the range of 0.3 to 0.8 mL/g. The average pore radii are 5 to 40 nm, in particular 10 to 30 nm. The pore volume and pore diameter distribution can be determined by mercury porosimetry according to ISO 15901-1:2022.

Preferably, the doped refractory oxide has a particle size d₉₀ in the range of from 10 μm to 35 μm, preferably in the range of from 15 μm to 30 μm, particularly preferably in the range of from 19 μm to 24 μm. The d₉₀ value indicates that 90% of the particles have a diameter below this value. The particle size distribution can be determined by laser diffraction according to ISO 13320.

The doped refractory oxide is provided at least with ruthenium. The ruthenium forms at least part of the catalytically active component of the catalytically active composition.

The term “ruthenium” used does not contain any information about the oxidation state of ruthenium. In other words, it does not indicate the presence of the elemental state having an oxidation state of 0. The ruthenium can be present on the doped refractory oxide in elemental form, i.e. in the oxidation state (0) or in a higher oxidation state. The term “oxidation state” used herein and known to those skilled in the art means the formal charge of an atom within a compound or the actual charge of monatomic ions. Atoms in the elemental state have, by definition, the oxidation state 0.

The doped refractory oxide being provided with ruthenium is understood to mean that ruthenium is carried on the doped refractory oxide, i.e. that the ruthenium is present in or on the doped refractory oxide, for example in the form of particles or a layer, whereby this layer is preferably a non-closed layer. The terms “provided” and “carried” are used synonymously and interchangeably in this application. The provision of the doped refractory oxide can take place both on the surface and inside the doped refractory oxide. The term “surface” includes both the outer and the inner surface, i.e, the inner surface formed by pores is also included.

Typically, the doped refractory oxide is provided with 0.1 wt. % to 25 wt. %, preferably 0.1 wt. % to 20 wt. %, more preferably 0.5 wt. % to 15 wt. %, particularly preferably 1.0 wt. % to 10 wt. % ruthenium, based on the total amount of doped refractory oxide and ruthenium.

Preferably, the catalytically active composition comprises ruthenium in an amount of 0.05 to 20 wt. %, preferably 0.5 to 18 wt. %, more preferably 1.0 to 13 wt. %, for example 0.05 wt. %, 0.1 wt. %, 0.5 wt. %, 1 wt. %, 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 15 wt. %, 18 wt. %, 20 wt. % or intermediates thereof, based on the total amount of doped refractory oxide, ruthenium, cerium-zirconium oxide and optionally further noble metals.

The provision of the doped refractory oxide with ruthenium can take place using methods known to those skilled in the art, for example by impregnation, precipitation, chemical vapor deposition (CVD), coating processes or spraying processes. The provision can be carried out in one or more steps.

The provision typically comprises bringing the doped refractory oxide together with at least one ruthenium compound, which is usually provided in a composition comprising at least one solvent. After bringing them together, precipitation and/or reduction of the at least one ruthenium compound as well as a drying and/or calcination step can take place.

For example, the composition can be taken up, driven by capillary forces, in or into the doped refractory oxide so that the volume of the composition approximately corresponds to the pore volume of the doped refractory oxide, known to those skilled in the art as “incipient wetness method”.

In this case, a “solvent” means that the solvent comprises at least one liquid substance in which the at least one ruthenium compound is soluble. The at least one solvent can comprise a plurality of chemical substances, i.e., the solvent can also be a solvent mixture.

The at least one solvent can be selected from the group consisting of water and organic solvents. The organic solvent can be selected from a plurality of commercially available organic solvents. The organic solvent is expediently substantially volatile under the processing conditions of the composition. Organic solvents can be, for example, alcohols such as methanol or ethanol.

In a preferred embodiment, the composition comprises 20 to 99.5 wt. %, preferably 30 to 95 wt. %, of the solvent, based on the total weight of the composition. Advantageously, the composition comprises at least 50 wt. %, particularly preferably at least 80 wt. %, very particularly preferably at least 90 wt. % of the solvent.

The composition also contains at least one ruthenium compound.

The amount of ruthenium in the composition can vary widely and is determined by the intended loading of the doped refractory oxide with ruthenium. The “amount of ruthenium” refers to the proportion of ruthenium in the composition, in other words it thus does not refer to the amount of the overall ruthenium compound. Preferably, the composition comprises 0.5 to 80 wt. % ruthenium, based on the total weight of the composition comprising the at least one solvent and the ruthenium compound. In one embodiment, the composition comprises 1 to 60 wt. % ruthenium, preferably 5 to 50 wt. %. Particularly good results are obtained when the composition contains ruthenium in an amount of at least 0.5 wt. %, in particular at least 1 wt. %, preferably at least 5 wt. %, preferably at least 10 wt. %.

The composition may contain only one ruthenium compound or a plurality of ruthenium compounds. Suitable ruthenium compounds are, for example, Ru salts, Ru complex compounds or Ru organometallic compounds, for example nitrates, acetylacetonates or acetates, but also a plurality of other salts which are known to those skilled in the art or which can be discovered by simple experiments. The ruthenium compound is preferably a halogen-free ruthenium compound. Examples of suitable ruthenium compounds include ruthenium nitrate, ruthenium acetate, ruthenium pentacarbonyl, ruthenium acetylacetonate, ruthenium oxalate, ruthenocene and ruthenium nitrosyl nitrate.

Preferably, providing the doped refractory oxide with ruthenium involves a drying step in which at least some of the solvent is removed from the composition.

Preferably, providing the doped refractory oxide with ruthenium may involve a calcination step. “Calcination” is understood by those skilled in the art to mean thermal treatment in which a metal component is preferably fixed to a carrier material. The calcination step is particularly advantageous if the temperature is in the range from 150 to 700° C., in particular 200 to 600° C. In preferred embodiments, the temperature is more than 200° C., particularly preferably more than 300° C. In preferred embodiments, the calcination step takes place over a period of 1 to 24 hours, preferably 2 to 12 hours.

The doped refractory oxide may be provided with at least one other noble metal selected from the group consisting of platinum (Pt), palladium (Pd), iridium (Ir), rhodium (Rh) and combinations thereof. In such cases, the ruthenium and the at least one other noble metal form at least part of the catalytically active component of the catalytically active composition. The combination of ruthenium with at least one other noble metal has proven to be particularly advantageous with regard to the long-term stability and the light-off temperature of the catalytically active composition.

The terms “metal”, “noble metal” or for example “platinum” used here do not contain any information about their oxidation state. In other words, it does not indicate the presence of the elemental state having an oxidation state of 0. The metal, noble metal or, for example, platinum can be in elemental form, i.e. in the oxidation state (0) or in a higher oxidation state.

In particular, it has proven advantageous if the doped refractory oxide is provided with a combination of ruthenium and iridium, ruthenium and platinum, ruthenium and palladium, ruthenium, platinum and iridium, ruthenium, palladium and iridium or ruthenium, palladium and platinum. In particularly preferred embodiments, the doped refractory oxide is provided with ruthenium and iridium or ruthenium, platinum and iridium.

Preferably, the doped refractory oxide is provided with ruthenium and the at least one other noble metal in an amount of 0.2 to 30 wt. %, preferably 0.5 to 25 wt. %, more preferably 1 to 20 wt. %, particularly preferably 5 to 15 wt. %, based on the total amount of doped refractory oxide, ruthenium and the at least one other noble metal.

If the doped refractory oxide is provided with at least one other noble metal, ruthenium and the at least one other noble metal are preferably present in a molar ratio in the range from 1:20 to 20:1, in particular in a ratio of 1:10 to 10:1.

In the event that the doped refractory oxide is to be provided with ruthenium and at least one other noble metal, it may be preferable to simultaneously provide the doped refractory oxide with the ruthenium and the at least one other noble metal. In this case, the composition used to provide ruthenium may contain at least one other noble metal compound. The provision takes place in the manner already described for the provision of ruthenium. It may also be advantageous if the at least one other noble metal is provided in a separate composition which is brought into contact with the doped refractory oxide at the same time as the composition containing the ruthenium compound. The doped refractory oxide may also be provided with another noble metal in a separate step, which can be carried out after or before the provision of ruthenium.

The amount of the at least one other noble metal compound in the composition can vary widely and is determined by the intended loading of the doped refractory oxide with the at least one other noble metal. The “amount of the at least one other noble metal” refers to the proportion of the at least one other noble metal in the composition, in other words it does not refer to the amount of the at least one noble metal compound. Preferably, the composition comprises 0.5 to 80 wt. % of the at least one other noble metal, based on the total weight of the composition comprising the at least one solvent and the at least one noble metal compound. In one embodiment, the composition comprises 1 to 60 wt. %, preferably 5 to 50 wt. % of the at least one other noble metal. Particularly good results are obtained when the composition contains the at least one other noble metal in an amount of at least 0.5 wt. %, in particular at least 1 wt. %, preferably at least 5 wt. %, preferably at least 10 wt. %.

The composition may contain only one noble metal compound or a plurality of noble metal compounds. Suitable noble metal compounds are complexes, organometallic compounds or salts of the noble metal, for example nitrates, halides, acetylacetonates or acetates, but also a plurality of other salts which are known to those skilled in the art or which can be discovered through simple experiments.

In the case that the at least one noble metal comprises iridium, the at least one noble metal compound can be, for example, an Ir salt, an Ir complex compound or an Ir organometallic compound. Examples of suitable iridium compounds are iridium chloride, iridium acetate, iridium acetylacetonate, iridium sulfate, and dihydrogen hexachloroiridate.

In the case that the at least one noble metal comprises platinum, the at least one noble metal compound can be, for example, a Pt salt, a Pt complex compound or a Pt organometallic compound. The following may be mentioned as examples of suitable platinum compounds: a platinum halide, such as platinum(II) chloride or platinum(IV) chloride or an acid thereof, hexachloroplatinic acid or a salt of this acid, platinic acid or a salt of this acid, hydroxyethylammonium hexahydroxoplatinate, ammonium hexachloroplatinate, ammonium tetrachloroplatinate, potassium tetrachloroplatinate, potassium hexachloroplatinate, sodium tetrachloroplatinate, potassium tetrahydroxyplatinate, platinum nitrate, platinum sulfite, platinum ethanolamine, platinum acetylacetonate, platinum oxalate or a mixture of at least two of these compounds.

In the case that the at least one noble metal comprises palladium, the at least one noble metal compound can be, for example, a Pd salt, a Pd complex compound or a Pd organometallic compound. The following may be mentioned as examples of suitable palladium compounds: a palladium halide, such as palladium(II) chloride, palladium(II) bromide or palladium(IV) chloride or an acid thereof, palladium acetate, palladium nitrate, palladium acetylacetonate, palladium sulfate, palladium oxalate, hydroxyethylammonium hexahydroxopalladate, ammonium hexachloropalladate, ammonium tetrachloropalladate, potassium tetrachloropalladate, potassium hexachloropalladate, sodium tetrachloropalladate, potassium tetrahydroxypalladate, diamminedichloropalladium, tetraamine palladium nitrate, tetraamine palladium chloride, tetraamine palladium hydroxide, tetraamine palladium sulfate or a mixture of at least two of these compounds.

In order to remove the oxygen from the nitrogen oxides of the exhaust gas to be treated and at the same time to oxidize hydrocarbons and carbon monoxide, the catalytically active composition comprises a cerium-zirconium oxide which comprises at least one element other than cerium from the group of rare earths. Such cerium-zirconium oxides are known to those skilled in the art as oxygen storage components. Cerium zirconium oxide can be mixed oxides or mixtures of cerium oxide (CeO₂) and zirconium oxide (ZrO₂). According to the invention, the cerium-zirconium oxide comprises both cerium-rich oxides and zirconium-rich oxides.

The cerium-zirconium oxide preferably contains 10 to 90 wt. % zirconium oxide, preferably 15 to 80 wt. %, based on the total weight of the cerium-zirconium oxide.

The cerium-zirconium oxide comprises at least one element other than cerium from the group of rare earths. The at least one element from the group of rare earths is preferably present in the form of an oxide. Preferably, the at least one rare earth element is selected from the group consisting of neodymium (Nd), praseodymium (Pr), lanthanum (La) and hafnium (Hf). The cerium-zirconium oxide may, for example, comprise a cerium-zirconium-lanthanum oxide, a cerium-zirconium-yttrium oxide, a cerium-zirconium-lanthanum-yttrium oxide, a cerium-zirconium-neodymium oxide, a cerium-zirconium-praseodymium oxide, a cerium-zirconium-lanthanum-neodymium oxide, a cerium-zirconium-lanthanum-praseodymium oxide, a cerium-zirconium-lanthanum-neodymium-praseodymium oxide, or a combination thereof. The proportion of each of the rare earth oxides can be 2 wt. % to 20 wt. %, preferably 5 wt. % to 15 wt. %, based on the total weight of the oxygen storage component.

The catalytically active composition preferably comprises the cerium-zirconium oxide in a proportion of 5 to 50 wt. %, particularly preferably in a proportion of 10 to 40 wt. %, based on the total weight of the catalytically active composition.

It is preferred that the cerium-zirconium oxide has a BET surface area of at least 10 m²/g, in particular at least 20 m²/g. Typically, the BET surface area of the cerium-zirconium oxide is between 10 and 150 m²/g, preferably between 30 and 100 m²/g.

The cerium-zirconium oxide is preferably a porous material. The pore volume is typically in the range of 0.2 to 1.0 mL/g, in particular in the range of 0.3 to 0.8 mL/g. The average pore radii are approximately 5 to 20 nm, in particular 7 to 12 nm.

Preferably, the cerium-zirconium oxide has a particle size d₉₀ in the range of from 10 μm to 35 μm, preferably in the range of from 15 μm to 30 μm, particularly preferably in the range of from 19 μm to 24 μm.

The cerium-zirconium oxide can be provided with at least one noble metal, which is preferably selected from the group consisting of ruthenium (Ru), platinum (Pt), palladium (Pd), iridium (Ir), rhodium (Rh) and combinations thereof. To avoid any misunderstandings, it should be pointed out at this point that ruthenium thus also belongs to the group of noble metals. In such cases, the ruthenium and optionally other noble metals with which the doped refractory oxide is provided and the noble metal(s) with which the cerium-zirconium oxide is provided form the catalytically active component of the catalytically active composition.

In particular, it is advantageous for the cerium-zirconium oxide to be provided with at least one noble metal if the total proportion of noble metals in the catalytically active composition is greater than 5 wt. %, in particular greater than 10 wt. %. The total proportion of noble metals can be understood to mean all noble metals present in the catalytically active composition, in other words both the ruthenium and any other noble metals with which the doped refractory oxide is provided, as well as noble metals with which the cerium-zirconium oxide is provided.

The amount of the at least one noble metal with which the cerium-zirconium oxide is provided is preferably 0.05 wt. % to 15 wt. % based on the total amount of cerium-zirconium oxide and the at least one noble metal, in particular 0.1 wt. % to 10 wt. %, very particularly 0.5 wt. % to 5 wt. %.

In particular, it has proven advantageous if the cerium-zirconium oxide is provided with ruthenium, ruthenium and iridium, ruthenium and platinum, ruthenium and palladium or ruthenium, iridium and platinum.

Providing the cerium-zirconium oxide with at least one noble metal can be carried out using methods known to those skilled in the art, as when providing the doped refractory oxide with at least one noble metal, for example by impregnation, precipitation, chemical vapor deposition (CVD) or spraying process. The above statements regarding the provision for the doped refractory oxide also apply to the provision for the cerium-zirconium oxide.

The noble metal provision for the cerium-zirconium oxide can be the same or different to the noble metal provision for the doped refractory oxide. In preferred embodiments, the noble metal provisions for the doped refractory oxide and the cerium-zirconium oxide are different. In other words, the catalytically active components carried on the doped refractory oxide and the cerium-zirconium oxide differ. For example, the noble metal or noble metals, the combination of noble metals, the loading of noble metal or noble metals, the shape or size of the noble metal particles with which the doped refractory oxide and the cerium-zirconium oxide are provided may be different. It should be noted at this point that the provision for the doped refractory oxide and the cerium-zirconium oxide also differs in cases where the cerium-zirconium oxide is not provided with any catalytically active component. Providing the doped refractory oxide and the cerium-zirconium oxide with different noble metals makes it possible to targetedly combine the noble metal and carrier material in order to achieve maximum efficiency of the different species and the separation of different noble metal species from one another. This can lead to a further increase in catalytic activity. In particular in cases where the catalytically active composition is provided with at least one other noble metal in addition to ruthenium, a different provision can be advantageous.

For example,
the doped refractory oxide may be provided with ruthenium and the cerium-zirconium oxide may not be provided with any noble metal,
the doped refractory oxide may be provided with ruthenium and the cerium-zirconium oxide may be provided with ruthenium,
the doped refractory oxide may be provided with ruthenium and the cerium-zirconium oxide may be provided with platinum,
the doped refractory oxide may be provided with ruthenium and the cerium-zirconium oxide may be provided with iridium,
the doped refractory oxide may be provided with ruthenium and the cerium-zirconium oxide may be provided with ruthenium and platinum,
the doped refractory oxide may be provided with ruthenium and the cerium-zirconium oxide may be provided with ruthenium and iridium,
the doped refractory oxide may be provided with ruthenium and the cerium-zirconium oxide may be provided with platinum and iridium,
the doped refractory oxide may be provided with ruthenium and the cerium-zirconium oxide may be provided with ruthenium, platinum and iridium,
the doped refractory oxide may be provided with ruthenium and platinum and the cerium-zirconium oxide may not be provided with any noble metal,
the doped refractory oxide may be provided with ruthenium and platinum and the cerium-zirconium oxide may be provided with ruthenium,
the doped refractory oxide may be provided with ruthenium and platinum and the cerium-zirconium oxide may be provided with platinum,
the doped refractory oxide may be provided with ruthenium and platinum and the cerium-zirconium oxide may be provided with iridium,
the doped refractory oxide may be provided with ruthenium and platinum and the cerium-zirconium oxide may be provided with ruthenium and platinum,
the doped refractory oxide may be provided with ruthenium and platinum and the cerium-zirconium oxide may be provided with ruthenium and iridium,
the doped refractory oxide may be provided with ruthenium and platinum and the cerium-zirconium oxide may be provided with platinum and iridium,
the doped refractory oxide may be provided with ruthenium and platinum and the cerium-zirconium oxide may be provided with ruthenium, platinum and iridium,
the doped refractory oxide may be provided with ruthenium and iridium and the cerium-zirconium oxide may not be provided with any noble metal,
the doped refractory oxide may be provided with ruthenium and iridium and the cerium-zirconium oxide may be provided with ruthenium,
the doped refractory oxide may be provided with ruthenium and iridium and the cerium-zirconium oxide may be provided with platinum,
the doped refractory oxide may be provided with ruthenium and iridium and the cerium-zirconium oxide may be provided with iridium,
the doped refractory oxide may be provided with ruthenium and iridium and the cerium-zirconium oxide may be provided with ruthenium and platinum,
the doped refractory oxide may be provided with ruthenium and iridium and the cerium-zirconium oxide may be provided with ruthenium and iridium,
the doped refractory oxide may be provided with ruthenium and iridium and the cerium-zirconium oxide may be provided with platinum and iridium,
the doped refractory oxide may be provided with ruthenium and iridium and the cerium-zirconium oxide may be provided with ruthenium, platinum and iridium,
the doped refractory oxide may be provided with ruthenium, platinum and iridium and the cerium-zirconium oxide may not be provided with any noble metal,
the doped refractory oxide may be provided with ruthenium, platinum and iridium and the cerium-zirconium oxide may be provided with ruthenium,
the doped refractory oxide may be provided with ruthenium, platinum and iridium and the cerium-zirconium oxide may be provided with platinum,
the doped refractory oxide may be provided with ruthenium, platinum and iridium and the cerium-zirconium oxide may be provided with iridium,
the doped refractory oxide may be provided with ruthenium, platinum and iridium and the cerium-zirconium oxide may be provided with ruthenium and platinum,
the doped refractory oxide may be provided with ruthenium, platinum and iridium and the cerium-zirconium oxide may be provided with ruthenium and iridium,
the doped refractory oxide may be provided with ruthenium, platinum and iridium and the cerium-zirconium oxide may be provided with platinum and iridium, or
the doped refractory oxide may be provided with ruthenium, platinum and iridium and the cerium-zirconium oxide may be provided with ruthenium, platinum and iridium.

Furthermore, it has been shown to be advantageous with regard to the stability of the catalytically active composition if ruthenium in particular is mainly carried on the doped refractory oxide. In preferred embodiments, at least 60% of the total ruthenium contained in the catalytically active composition is carried on the doped refractory oxide, particularly preferably more than 75%, very particularly preferably more than 95%.

Preferably, the catalytically active composition comprises noble metals in an amount of 0.5 to 35 wt. %, preferably 1 to 30 wt. %, more preferably 5 to 25 wt. %, for example 1 wt. %, 2 wt. %, 3 wt. %, 4 wt. %, 5 wt. %, 6 wt. %, 7 wt. %, 8 wt. %, 9 wt. %, 10 wt. %, 15 wt. %, 20 wt. %, 25 wt. %, 30 wt. %, 35 wt. % or intermediates thereof, based on the total amount of doped refractory oxide, ruthenium, cerium-zirconium oxide and optionally further noble metals.

The catalytically active composition may also contain other components, such as fillers, binders, pore formers, stabilizers or rheology modifiers. Such additional components typically do not exhibit catalytic activity for the desired reaction, but instead improve the effectiveness of the catalytically active composition, for example by increasing the operating temperature range, increasing the contact surface, improving the adhesion properties of the catalytically active composition to a substrate, or the like.

Preferably, the catalytically active composition is prepared by a method comprising the following steps:
i) providing the doped refractory oxide which is provided at least with ruthenium and is selected from the group consisting of aluminum oxide, magnesium oxide, silicon oxide, molybdenum oxide, tungsten oxide, titanium oxide, mixtures thereof and composite oxides of two or more thereof,
ii) providing the cerium-zirconium oxide which comprises at least one element other than cerium from the group of rare earths,
iii) mixing the doped refractory oxide provided at least with ruthenium, and the cerium-zirconium oxide.

The invention also relates to a method for preparing a catalytically active composition according to the invention, comprising the above-mentioned steps. For preferred embodiments of the individual components, reference is made to the above statements.

Surprisingly, it has been found that providing ruthenium to the doped refractory oxide prior to the preparation of the catalytically active composition improves the long-term stability of the catalytic activity of the composition. In addition, positive effects on the light-off temperature of a catalytically active composition prepared according to the invention were surprisingly observed.

In particular, the provision for the doped refractory oxide in a method using a halogen-free ruthenium compound has proven to be advantageous with regard to the long-term stability and efficiency of the catalytically active composition. For examples of suitable ruthenium compounds, reference is made to the above statements.

In step iii), the doped refractory oxide provided at least with ruthenium and the cerium-zirconium oxide are mixed. Mixing is carried out according to methods known to those skilled in the art or in systems known to those skilled in the art with the aim of homogeneously mixing the components as much as possible. For example, mixing takes place in a screw, ribbon, paddle, blade, rotor, drum, double-cone or V-mixer.

The invention also relates to a preparation containing
a) a catalytically active composition according to the invention, and
b) a liquid, preferably water.

The preparation is preferably in the form of a suspension. A suspension within the sense of the present invention is a mixture of a solid and a liquid, wherein the solid is in the form of finely divided solid bodies evenly distributed in the liquid.

Such preparations are also referred to as a “washcoat suspension”. The term “washcoat” is known to those skilled in the art. A distinction must be made between a washcoat suspension and a washcoat layer that is or can be applied to a macroscopic carrier.

At this point it should be emphasized that the preparation according to the invention already contains at least one catalytically active species, namely at least the ruthenium applied to the doped refractory oxide. This distinguishes the preparation according to the invention from preparations known in the art which contain precursor compounds of a catalytically active species.

The preparation may also contain other components such as acids or bases for pH regulation, binders, adhesion promoters or stabilizers. The preparation preferably contains between 10 and 70 wt. % of solid components, particularly preferably between 30 and 50 wt. %, based on the total mass of solid components and the liquid.

The preparation according to the invention can preferably be prepared by a method comprising the following steps:
i) providing the doped refractory oxide which is provided at least with ruthenium and is selected from the group consisting of aluminum oxide, magnesium oxide, silicon oxide, molybdenum oxide, tungsten oxide, titanium oxide, mixtures thereof and composite oxides of two or more thereof,
ii) providing the cerium-zirconium oxide which comprises at least one element other than cerium from the group of rare earths,
iii) providing a liquid, preferably water,
iv) mixing the doped refractory oxide provided at least with ruthenium, the cerium-zirconium oxide and the liquid.

The individual components can also be mixed with the liquid separately from one another; in other words, the doped refractory oxide provided with ruthenium and the cerium-zirconium oxide can each be separately mixed with the liquid and these mixtures can then be mixed. In further embodiments, one of the two components can also be mixed with the liquid first and then the other component can be added to the mixture obtained. It may also be preferable to first mix the two oxides together and then mix this mixture with the liquid.

Optionally, the method for preparing the preparation may also comprise further steps.

For example, the method may include a pH-adjustment step or a grinding step. The grinding step may comprise grinding the doped refractory oxide provided at least with ruthenium and/or the cerium-zirconium oxide. Grinding may be performed before or after mixing the doped refractory oxide provided at least with ruthenium with the cerium-zirconium oxide and the liquid.

The present invention also relates to a method for preparing a preparation according to the invention.

Typically, the catalytically active composition is in the form of a catalytically active coating. As is known to those skilled in the art, the catalytically active composition is present on a macroscopic carrier, typically on a heat-resistant carrier in such cases. In this context, the term “macroscopic carrier” is to be understood in a manner that distinguishes it from the “microscopic carrier(s)” on which the catalytically active component or catalytically active components are carried. In the present invention, the microscopic carrier thus comprises the doped refractory oxide and the cerium-zirconium oxide.

The invention also relates to a catalytically active coating comprising
a) a doped refractory oxide provided at least with ruthenium, selected from the group consisting of aluminum oxide, magnesium oxide, silicon oxide, molybdenum oxide, tungsten oxide, titanium oxide, mixtures thereof and composite oxides of two or more thereof, and
b) a cerium-zirconium oxide which comprises at least one element other than cerium from the group of rare earths.

For preferred embodiments of the catalytically active coating, reference is made to the above statements regarding the catalytically active composition, which also apply to the catalytically active coating according to the invention.

In principle, the heat-resistant carrier can have any shape or size. In general, the heat-resistant carrier has a plurality of channels arranged side by side or an open-pored foam structure with interconnected cavities through which gases can flow. The shape and size of the heat-resistant carrier is usually chosen so that the effect of the catalytically active composition, or the catalytically active coating, in the catalyst on the exhaust gas is optimized. Examples of suitable shapes of the heat-resistant carrier include bulk materials, monolithic honeycombs or honeycomb bodies, layered fibrous bodies or warp knitted fabrics, foams, nets, weft knitted fabrics, porous bodies or particles. In the case of bulk material catalysts, the heat-resistant carrier is preferably in the form of a shaped body (such as granules, pellets, or extrudates, such as cylinders, rings, spheres, cuboids, small plates). The diameter or size of such bulk material shaped bodies can, for example, be in the range of about 1 to 20 mm.

The heat-resistant carrier typically comprises a ceramic material or a metal material. Preferably, the heat-resistant carrier can be cordierite (SiO₂—Al₂O₃—MgO), silicon carbide (SiC), titanium, an iron alloy, such as an Fe—Cr—Al alloy, or an Ni—Cr—Al alloy or an alloy of a stainless steel.

Methods for preparing catalytically active coatings are known to those skilled in the art. For example, the preparation can be carried out by applying preparations according to the invention to a suitable heat-resistant carrier. The application process may involve spraying the preparation or immersing the heat-resistant carrier in a washcoat suspension.

For example, such a method comprises the steps of
i) providing a preparation containing
   a) a catalytically active composition according to the invention, and
   b) a liquid, preferably water,
ii) providing a heat-resistant carrier,
iii) applying the preparation to the heat-resistant carrier.

The present invention also relates to a method comprising the above-mentioned steps. In such a method, a coated heat-resistant carrier is thus obtained.

If the method comprises only steps i), ii) and iii), a liquid-containing catalytically active coating is obtained, in other words, the catalytically active coating can be in the form of a “wet washcoat layer”.

The preparation can be applied to the heat-resistant carrier in one or more steps.

The method of preparing the catalytically active coating may also comprise further steps.

Preferably, the coated heat-resistant carrier can be dried and/or calcined in a further step. In such cases, the catalytically active coating is obtained as a dried or calcined washcoat layer.

The drying step is preferably carried out at a temperature in the range of 50 to 200° C., particularly preferably between 8° and 150° C. In preferred embodiments, the drying step is carried out over a period of 0.5 to 10 hours, preferably over 2 to 8 hours.

The calcination step is particularly advantageous if the temperature is in the range from 100 to 700° C., in particular 150 to 500° C. In preferred embodiments, the temperature is more than 200° C., particularly preferably more than 300° C. In preferred embodiments, the calcination step takes place over a period of 1 to 12 hours, preferably over 2 to 10 hours.

The amount of the preparation applied to the heat-resistant carrier can be determined on the basis of the desired loading of the macroscopic carrier with the catalytically active component. The loading of the heat-resistant carrier can, as is known to those skilled in the art, be controlled, for example, by the rheological properties of the preparation.

In addition, the method steps of applying the preparation and optionally drying and/or calcining said heat-resistant carrier to prepare the washcoat layer can be repeated as needed to achieve the desired degree of loading or the desired thickness.

The present invention also relates to a catalyst comprising the catalytically active composition according to the invention or the catalytically active coating and a heat-resistant carrier.

The catalyst can be in the form, for example, of a monolith catalyst coated with a washcoat layer, a bulk material shaped body coated with a washcoat layer, or a metal honeycomb or weft-knitted metal catalyst coated with a washcoat layer. In such cases, the washcoat layer comprises the catalytically active composition or the catalytically active coating.

Methods for preparing catalysts with catalytically active coatings are known in principle to those skilled in the art. For example, such a method may comprise the following steps:
i) providing a preparation containing
   a) a catalytically active composition according to the invention, and
   b) a liquid, preferably water,
ii) providing a heat-resistant carrier,
iii) applying the preparation to the heat-resistant carrier,
iv) drying and/or calcining the coated heat-resistant carrier.

For preferred embodiments, reference is made to the above statements regarding the preparation of the catalytically active coating, which also apply to the preparation of catalysts according to the invention.

After drying and/or calcining, the catalytically active coating is considered to be substantially solvent-free. The resulting loading of the heat-resistant carrier can accordingly be determined by determining the difference between the weight of the coated and the uncoated heat-resistant carrier.

The loading of the catalyst with the catalytically active composition or the catalytically active coating is selected such that the device as a whole is used as efficiently as possible. The catalyst is preferably loaded with from 30 to 250 g/L, particularly preferably from 50 to 200 g/L, particularly preferably from 75 to 150 g/L of the catalytically active composition. The loading indicates the amount of coating applied based on the empty volume of the heat-resistant carrier.

By using the catalytically active composition according to the invention or the catalytically active coating according to the invention, catalysts with particularly low total loadings of ruthenium are possible, for example in the range of 0.1 to 15 g/L, more preferably 0.5 to 12 g/L, particularly preferably 1 to 10 g/L.

In the case of catalytically active compositions which contain other noble metals in addition to ruthenium, the total loading is preferably in a range of 1 to 30 g/L, more preferably 1.5 to 25 g/L, particularly preferably 3 to 20 g/L.

A catalyst according to the invention can be used, for example, in small engines, in motorcycles, in the automotive industry, in commercial vehicles, for industrial and special applications and in marine applications.

The present invention also relates to a method for exhaust-gas aftertreatment, wherein an exhaust gas stream is brought into contact with a catalytically active composition according to the invention, a catalytically active coating according to the invention or a catalyst according to the invention.

Exhaust gas aftertreatment preferably takes place at a temperature in the range of 150 to 500° C.

The exhaust gases can come, for example, from incinerators, gas turbines, industrial plants or internal combustion engines. Particularly preferred is the treatment of exhaust gases from internal combustion engines, in particular small engines, 2-stroke engines and engines that operate in the “rich” lambda range. The combustion exhaust gases typically contain carbon monoxide, hydrocarbons and/or other volatile organic compounds and/or nitrogen oxides.

Volatile organic compounds (VOCs) are understood to mean gaseous or volatile organic compounds, such as organic compounds with a boiling point of, for example, up to 300° C. or with sublimation behavior. Typical examples of such VOCs are hydrocarbons and organic solvents as used, for example, in chemical production, paint or adhesive production or processing, cleaning processes, etc. For example, hydrocarbons can also enter the exhaust air when dealing with fossil fuels, for example during their production or distribution. Other examples of VOCs are organic residual monomers from the production and processing of polymers or odorants, such as those produced in the food sector (food production, animal fattening, roasting plants, fermentation processes, etc.).

The measurement methods used in the present invention are specified below. If no test method is specified, the appropriate ISO method, as valid on the filing date of the present application, was used to determine the parameter in question. If no specific measurement conditions are indicated, the measurement was carried out at room temperature (298.15 K) and standard pressure (100 kPa).

### BET Specific Surface Area

The BET specific surface area was determined with nitrogen as an adsorbate at 77 K according to the BET theory (multipoint method, ISO 9277:2010).

### Pore Volume and Pore Diameter Distribution

The pore volume and pore diameter distribution were determined by mercury porosimetry according to ISO 15901-1:2022.

Particle Size Distribution (d₉₀)

The particle sizes were determined by laser diffraction according to ISO Standard 13320 using a Mastersizer 2000 (Malvern).

### Determination of Noble Metal Content Via ICP-MS

The noble metal content was determined using inductively coupled plasma mass spectrometry (ICP-MS). For this purpose, each sample was digested in HF+HCl.

### Long-Term Stability

The catalysts were treated at 1050° C. in air for 16 h before testing the catalytic activity. This resulted in artificial aging, simulating the exposure of the catalyst under typical application conditions.

### Testing the Catalytic Activity

The catalysts were examined in a specially constructed catalyst test facility. A gas mixture consisting of synthetic air with 5000 vol·ppm CO, 1000 vol·ppm NOₓ, 500 vol·ppm propane and 0.3% oxygen was passed over the catalysts at a rate of 70000 h⁻¹ as the temperature increased.

The proportions of CO, NOₓ and propane in the gas mixture were measured before and after the catalyst using FT-IR and FID, and the oxygen content was measured using a paramagnetic detector. On the basis thereof, the conversion (C) was determined in each case. To determine the light-off temperature (T50), the conversion curves obtained in this way were evaluated and the temperature at which 50% conversion occurs was determined each time.

The invention is explained in more detail with reference to the following examples. However, the examples should not be understood to be limiting.

For all examples, an La₂O₃-doped Al₂O₃ and an Nd₂O— and La₂O₃-doped CeZr oxide was used. Both oxides are commercially available.

### CE—(Comparative Example: Ru/Al₂O₃+Ru/CeZr Oxide)

80 g Al₂O₃ were impregnated with a solution of ruthenium nitrosyl nitrate (Ru—NN) containing 80% of the Ru to be applied and then dried, and 20 g of CeZr oxide were also treated with an Ru—NN solution containing 20% of the Ru to be applied. For calcination, the previously dried material was treated in an oven at 500° C. for 4 h.

The Al₂O₃ provided with Ru was slurried in water, then the CeZr oxide provided with Ru was added. The resulting suspension was ground. The ground suspension was applied to a ceramic honeycomb substrate. The coated honeycomb was calcined at 550° C. for 4 h. The resulting washcoat loading was 100 g/L, corresponding to a ruthenium content of 3.5 g/L.

FIG. 1 shows the temperature-dependent conversion of NOₓ and HC of the freshly prepared catalyst.

### IE1 (Ru/Al₂O₃)

80 g Al₂O₃ were impregnated with an Ru—NN solution containing 90% of the Ru to be applied and then dried, and 20 g of CeZr oxide were also treated with an Ru—NN solution containing 10% of the Ru to be applied. For calcination, the dried material was treated in an oven at 500° C. for 4 h. The Al₂O₃ provided with Ru was slurried in water, then the CeZr oxide provided with Ru was added and the entire suspension was ground. The ground suspension was applied to a ceramic honeycomb substrate. The coated honeycomb was calcined at 550° C. for 4 h. The resulting washcoat loading was 100 g/L, which corresponded to a ruthenium content of 10.6 g/L.

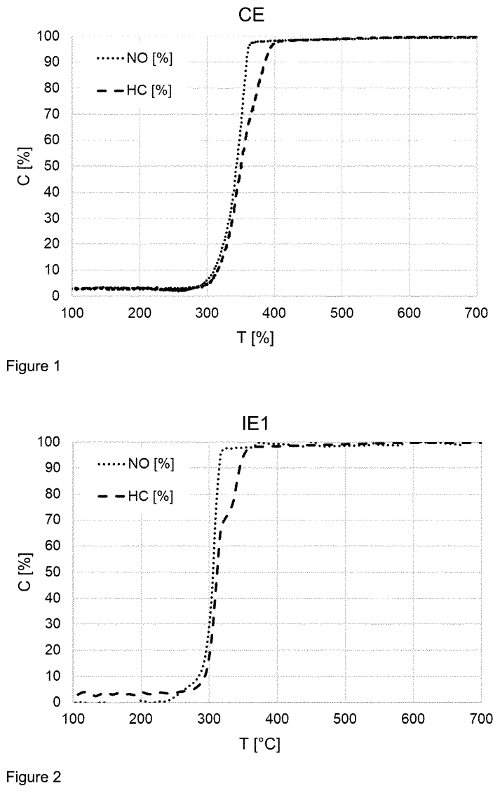

Using the NOₓ and HC conversion, FIG. 2 illustrates the catalyst performance of the catalyst prepared according to the invention.

### IE2 (Ru/Al₂O₃)

The preparation procedure was carried out analogously to the method given in IE1, but only the Al₂O₃ was treated with an Ru—NN solution containing 100% of the Ru to be applied. The resulting washcoat loading was 100 g/L, corresponding to a ruthenium content of 3.5 g/L.

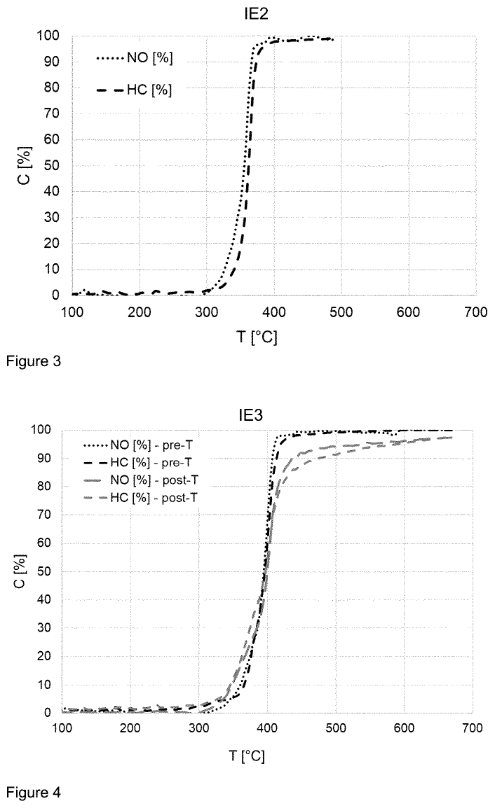

FIG. 3 shows the catalyst performance of this catalyst according to the invention. In addition to the catalyst performance of the freshly prepared catalyst (pre-T), the performance after artificial aging (post-T) is compared. The almost identical curves illustrate the particular stability of the catalyst.

### IE3 (Ru/Al₂O₃)

The preparation procedure was carried out analogously to the method given in IE2, but less Ru—NN was used in the solution. The resulting washcoat loading was 100 g/L, which corresponded to a ruthenium content of 1.8 g/L.

FIG. 4 shows the catalyst performance of this catalyst according to the invention.

### IE4 (RuIr/Al₂O₃)

The preparation procedure was carried out analogously to the method given in IE2. For impregnation of the Al₂O₃, a solution of Ru—NN and iridium as iridium chloride in water was used. The resulting washcoat loading was 100 g/L, which corresponded to a ruthenium content of 1.8 g/L.

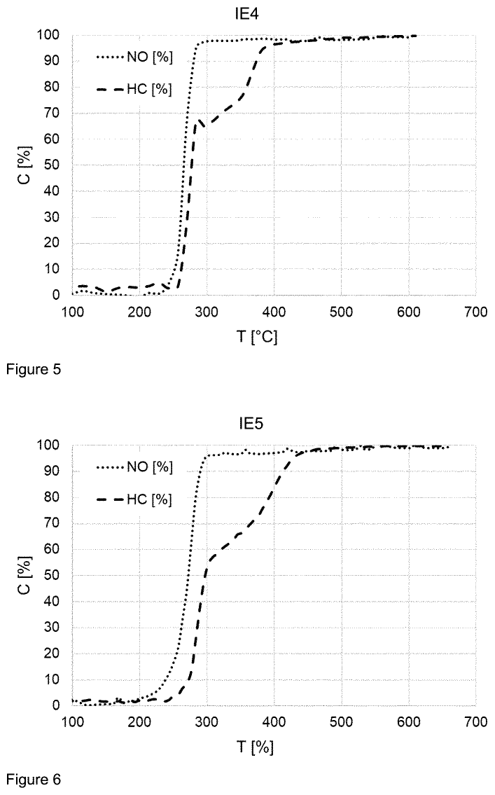

FIG. 5 shows the catalyst performance of this catalyst according to the invention.

### IE5 (RuPt/Al₂O₃)

The preparation procedure was carried out analogously to the method given in IE2. For impregnation of the Al₂O₃, a solution of Ru—NN and platinum as platinum nitrate in water was used. The resulting washcoat loading was 100 g/L, which corresponded to a ruthenium content of 1.8 g/L.

FIG. 6 shows the catalyst performance of this catalyst according to the invention.

### IE6 (RuIr/Al₂O₃+RuPt/CeZr oxide)

Al₂O₃ was slurried in water and mixed with an Ru—NN solution and iridium chloride in water. The suspension was heated, then an NaOH solution was added and the solid phase was separated from the liquid phase by filtration.

CeZr oxide was slurried in water and mixed with an Ru—NN solution and platinum nitrate in water. The suspension was heated, an NaOH solution was then added and the solid phase was separated from the liquid phase by filtration.

The two oxides provided with the precipitated noble metals were mixed, dried and treated for calcination purposes in an oven at 400° C. for 2 h. The calcined material was slurried in water and ground.

The coating of a ceramic honeycomb body was carried out in a similar way to that described in IE2. The resulting loading was 100 g/L, which corresponded to a ruthenium content of 1.8 g/L.

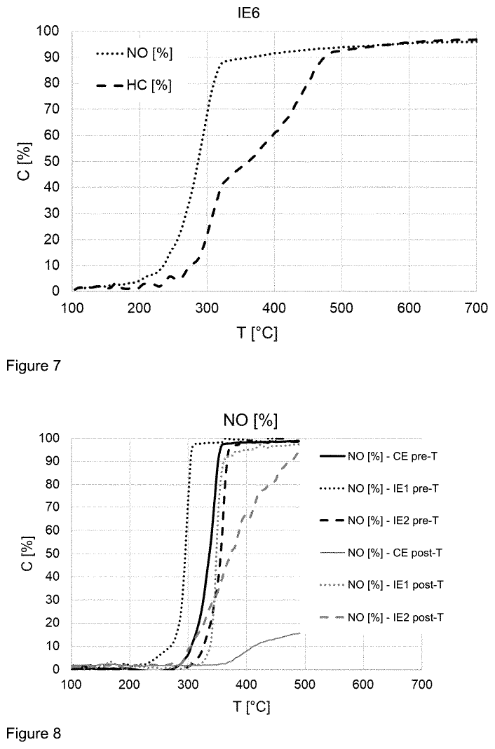

FIG. 7 shows the catalyst performance of this catalyst according to the invention.

TABLE 1
summarizes the features of the tested catalysts and the
corresponding total noble metal loading.

| | | Precious metal |
|---|---|---|
| | | loading [g/L] |
| CE | Ru/Al₂O₃ | 3.5 |
| | Ru/CeZr oxide | |
| IE1 | Ru/Al₂O₃ | 10.6 |
| | CeZr oxide | |
| IE2 | Ru/Al₂O₃ | 3.5 |
| | CeZr oxide | |
| IE3 | Ru/Al₂O₃ | 1.8 |
| | CeZr oxide | |
| IE4 | Rulr/Al₂O₃ | 2.7 |
| | CeZr oxide | |
| IE5 | RuPt/Al₂O₃ | 3.5 |
| | CeZr oxide | |
| IE6 | RuPtIr/Al₂O₃ | 4.4 |
| | Rulr/CeZr oxide | |

The results of IE1 to IE6 demonstrate that the various embodiments of the catalysts according to the invention are active in the removal of nitrogen oxides. Even a relatively low noble metal loading, as in IE3, is sufficiently effective. In particular, the combination of ruthenium with another noble metal also showed a beneficial reduction in T50.

FIG. 8 compares the catalytic activity for the NOx conversion of the catalysts according to CE, IE1 and IE2 containing only ruthenium before (pre-T) and after (post-T) temperature treatment. Before temperature treatment, the catalyst performances were similar. However, the catalytic activity, in particular the light-off temperature, of the catalysts according to the invention showed only a slight change after this artificial aging, whereas the catalyst of the comparative example (CE) clearly lost catalytic activity. In particular, the comparison between the catalysts of CE and IE2, which have the same ruthenium loading, illustrates the increased stability of the catalysts according to the invention. The carrying of the ruthenium on the Al₂O₃ presumably increases its stability and thus the catalytic effectiveness under operating conditions, making it possible to minimize the noble metal provision in the catalysts.

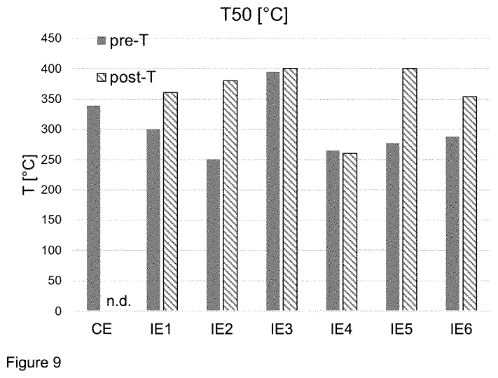

FIG. 9 compares the determined T50 values for the NOx conversion of the tested catalysts in the fresh and aged state. The T50 value could no longer be determined for the catalyst of the comparative example. In addition to lowering the light-off temperature, the combination of ruthenium with another noble metal, in particular iridium, proved to be beneficial for the stability of the catalysts.

1. A catalytically active composition, comprising
a) a doped refractory oxide which is provided at least with ruthenium and is selected from the group consisting of aluminum oxide, magnesium oxide, silicon oxide, molybdenum oxide, tungsten oxide, titanium oxide, mixtures thereof and composite oxides of two or more thereof, and
b) a cerium-zirconium oxide which comprises at least one element other than cerium from the group of rare earths.

2. The catalytically active composition according to claim 1, wherein the doped refractory oxide is an aluminum oxide or a mixed oxide or composite oxide of aluminum oxide.

3. The catalytically active composition according to claim 1, wherein the doped refractory oxide is a lanthanum oxide-doped aluminum oxide, a lanthanum oxide-doped mixed oxide of aluminum oxide or a lanthanum oxide-doped composite oxide of aluminum oxide.

4. The catalytically active composition according to claim 1, wherein the proportion of doped refractory oxide is in the range of 10 to 95 wt. %.

5. The catalytically active composition according to claim 1, wherein the doped refractory oxide is provided with 0.1 wt. % to 25 wt. % ruthenium, based on the total amount of doped refractory oxide and ruthenium.

6. The catalytically active composition according to claim 1, wherein the catalytically active composition comprises ruthenium in an amount of 0.05 to 20 wt. %, based on the total amount of doped refractory oxide, ruthenium and cerium-zirconium oxide.

7. The catalytically active composition according to claim 1, wherein the doped refractory oxide is provided with at least one other noble metal selected from the group consisting of platinum (Pt), palladium (Pd), iridium (Ir), rhodium (Rh) and combinations thereof.

8. The catalytically active composition according to claim 7, wherein the doped refractory oxide is provided with a combination of ruthenium and iridium; ruthenium and platinum; ruthenium and palladium; ruthenium, platinum and iridium; ruthenium, palladium and iridium or ruthenium, palladium and platinum.

9. The catalytically active composition according to claim 7, wherein the doped refractory oxide is provided with ruthenium and the at least one other noble metal in an amount of 0.2 to 30 wt. %, based on the total amount of doped refractory oxide, ruthenium and the at least one other noble metal.

10. The catalytically active composition according to claim 1, wherein the cerium-zirconium oxide is provided with at least one noble metal.

11. The catalytically active composition according to claim 1, wherein the noble metal provisions for the doped refractory oxide and the cerium-zirconium oxide are different.

12. A method for preparing a catalytically active composition according to claim 1, comprising the steps of:
i) providing the doped refractory oxide which is provided at least with ruthenium and is selected from the group consisting of aluminum oxide, magnesium oxide, silicon oxide, molybdenum oxide, tungsten oxide, titanium oxide, mixtures thereof and composite oxides of two or more thereof,
ii) providing the cerium-zirconium oxide which comprises at least one element other than cerium from the group of rare earths,
iii) mixing the doped refractory oxide provided at least with ruthenium, and the cerium-zirconium oxide.

13. A preparation, containing
a) a catalytically active composition according to claim 1, and
b) a liquid.

14. A catalyst comprising the catalytically active composition according to claim 1 and a heat-resistant carrier.

15. A method for exhaust-gas aftertreatment, wherein an exhaust gas stream is brought into contact with a catalytically active composition according to claim 1.
